(19) United States
(12) Patent Application Publication
(10) Pub. No.: US 2010/0026016 A1
(43) Pub. Date: Feb. 4, 2010

(54) TOGGLE LATCH

(75) Inventor: Filip Tejszerski, Newport (AU)

Correspondence Address: KELLY LOWRY & KELLEY, LLP, 6320 CANOGA AVENUE, SUITE 1650, WOODLAND HILLS, CA, 91367, US

(73) Assignee: D & D GROUP PTY LTD, Frenchs Forest (AU)

(21) Appl. No.: 12/349,005

(22) Filed: Jan. 6, 2009

Related U.S. Application Data
(63) Continuation-in-part of application No. 29/323,906, filed on Sep. 3, 2008, now Pat. No. D605493.

(30) Foreign Application Priority Data
Jul. 31, 2008 (AU) 321982

(51) Int. Cl. E05C 19/14

(52) U.S. Cl. 292/259 R; 292/359

(57) ABSTRACT

A toggle latch for a gate has a first unit mounting a pivotal latch arm and adapted to be mounted on the gate and a second unit providing a receiving and latching cavity and adapted to be mounted on a gate post, the body portion of the second unit having a forward nose to provide a ramp to deflect upwardly and over the nose the latch arm when impacting thereon and an interior retaining surface defined in the body and having upper and rear surfaces of the cavity to deflect down into the cavity the latch arm after it has ridden up over the nose.

### BACKGROUND OF THE INVENTION

The present invention relates to a toggle latch the typically application being to exterior gates where, on closing of the gate, there is automatic latching.

Toggle latches are known for gates and wherein a pivotal bar strikes on a closure ramp to be deflected upwardly and then drops down into a receiving cavity for latching purposes. Manual operation is usually provided for lifting the bar to undo the latch so the gate may be open.

Typically such toggle latches are made of metal components and usually are of a relatively crude and inexpensive form of construction.

### SUMMARY OF THE INVENTION

The present invention is directed to new and useful alternative designs of toggle latches and lends itself to embodiments which may be assessed as having improved functionality, performance and can be implemented with superior industrial design.

Broadly the present invention is directed to a toggle latch for latching together first and second structures when in juxtaposition for latching at a closed position,

the latch comprising a first unit having a body for mounting on the first structure,
a pivotally mounted latch arm projecting laterally and pivotal about a substantially horizontal axis,
a support for supporting the latch arm when free to limit normally downward pivoting of the latch arm,
a second unit for mounting on the second structure and receiving in latching engagement the latch arm, the second unit having a body portion within which a laterally directed aperture is defined for admitting the latch arm and a cavity for retaining the latch arm in latching engagement,
the body portion being characterized by a forward nose providing a ramp to deflect upwardly and over the nose the latch arm when impacting thereon, and an interior retainer surface defining upper and rear surfaces of the cavity and profiled to deflect down into the cavity the latch arm after it has ridden up over the nose.

Each of the units may be formed by molding for example in plastics to have an elongate body which may be of the order of 2 cm wide and having apertures for receiving fixing screws to be attached to the face of a gate and gate post. Each unit may be several centimeters in vertical extent and the invention can readily be implemented in a unit wherein the pivotal toggle latch arm can extend to the right or the left from the body, which is designed to be symmetrical and capable of inversion for mounting purposes.

A particularly advantageous embodiment is one wherein the surfaces defining the cavity for receiving a latching arm have a complex curve with a decreasing radius of curvature through the posterior surface and back towards a forward surface which is on the rear of the portion defining the forward nose for the deflecting ramp.

An embodiment of the invention will be described hereinafter for illustrative purposes only. In such an embodiment the latch may be described as being further characterised by a superior surface of the cavity having a lead-in surface above the ramp and extending rearwardly substantially horizontally and smoothly blending into an actuate posterior surface with a vertical gap between the rear, upper portion of the ramp to the superior surface of about 1.3 times the diameter of the latch arm and a horizontal gap between the end of the ramp and the posterior actuate surface of about 1.3 times the diameter of the latch arm.

### BRIEF DESCRIPTION OF THE DRAWINGS

In the accompanying drawings:

FIG. 1 is an isometric front view from the right of a toggle latch embodying the invention;

FIG. 2 is a front elevation of a toggle latch;

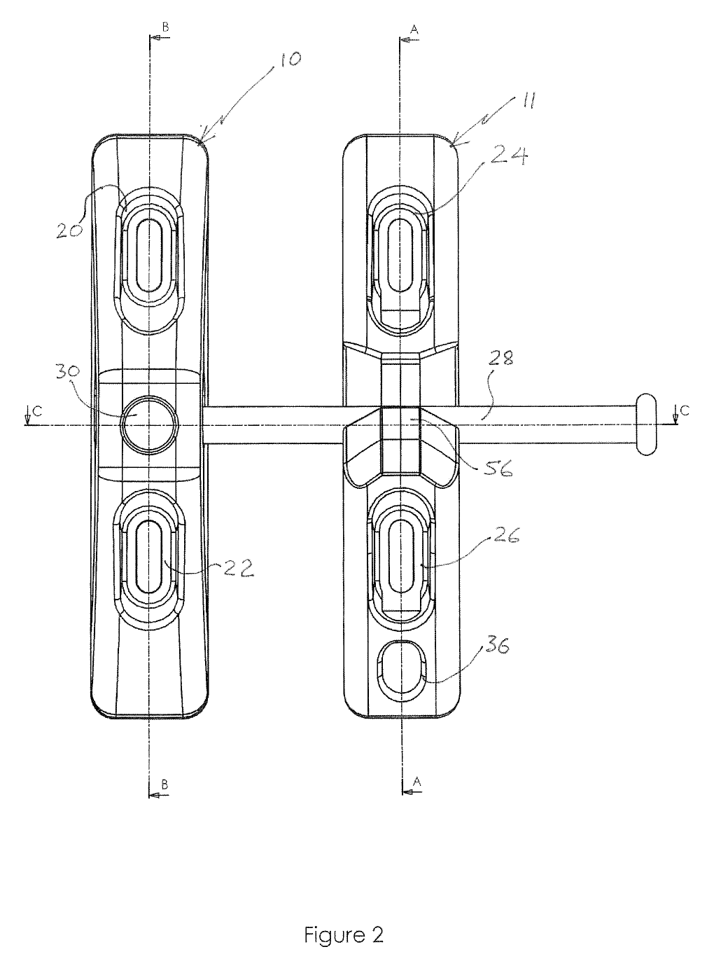

FIG. 3 is a right hand side elevation of the toggle latch;

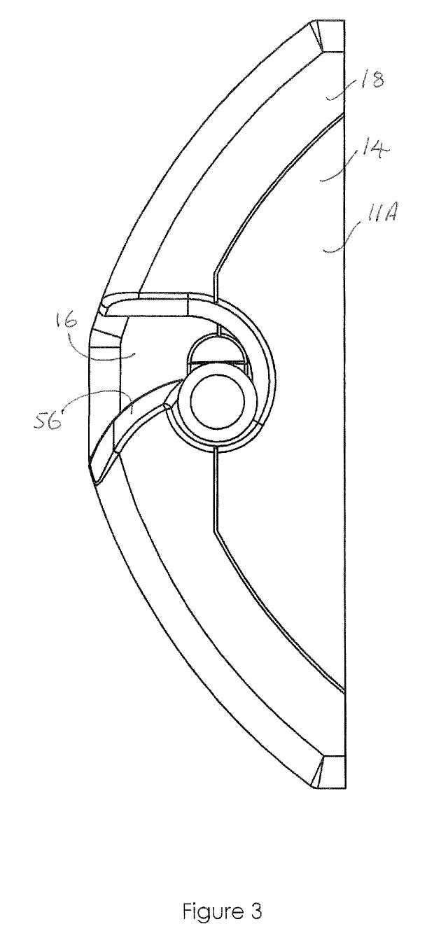

FIG. 4 is a sectional plan view along the line C-C of FIG. 2;

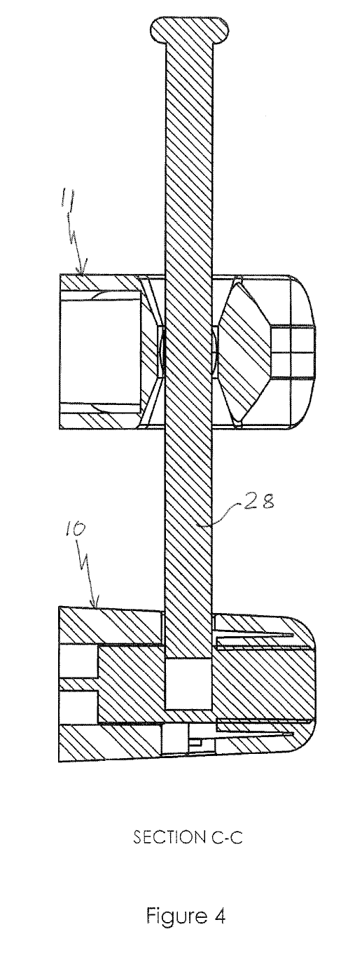

FIG. 5 is a section along the line B-B and being a central side elevation of the first unit mounting the toggle arm; and

FIG. 6 is a sectional side elevation taking along the line A-A of FIG. 2 and through the second unit.

### DETAILED DESCRIPTION OF THE PREFERRED EMBODIMENT

The toggle latch comprises a toggle latch unit 10 and a receiving unit 11 each having a housing with flat rear walls and adapted to be face mounted respectively on the edge of a gate and a gate post. Each of the units comprises an interconnected plastic two part body having a central back portion respectively 12 and 14 and an overlying curved front portion 16 and 18 providing respective housings 10A and 11A with upper and lower apertures 20 and 22 in the first unit 10 and 24 and 26 in the receiving unit 11. The apertures provide access for a screw driver to fit fixing screws through the base of each unit for mounting units.

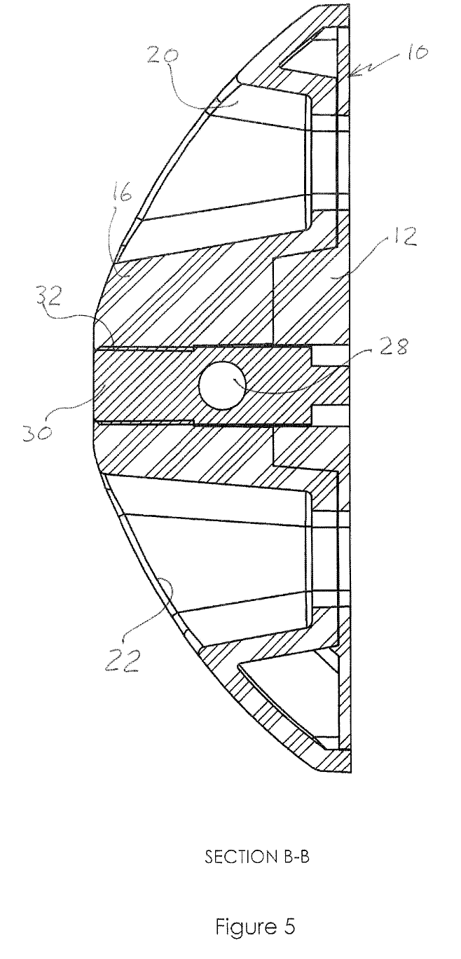

The toggle unit 10 has a pivotal toggle arm 28 typically of a suitable steel which is protected against corrosion and which is press fitted to and welded to a transverse circular cross section barrel 30 which has been located in a receiving cavity 32 in the molded body of parts 12 and 16 of the housing 10A. From FIG. 5 it would be apparent that the leading end of the barrel 30 has a chamfered face and engages rotatably behind a corresponding undercut lip of the cavity 32, the opposite end of the barrel 30 having a reduced dimension tab which is retained in a position after fitting to the toggle arm 28.

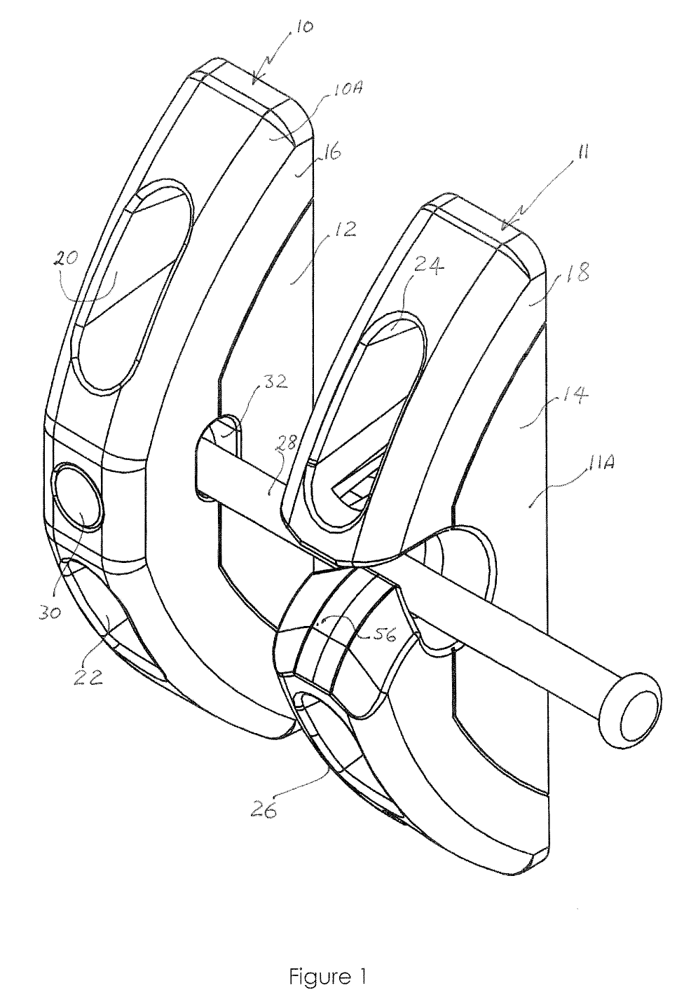

As most clearly shown in FIG. 1, an oval aperture 32 extends from the right hand face of the unit 10 through the body to intercept with the cavity 30 accommodating the barrel. In use the latch arm 28 falls under gravity and when the gate is open can rest of the lower edge of the cavity, but during closure of the gate the latch arm moves towards the upper extremity of the oval aperture. In the event that installation requires the toggle arm to be on the right of the receiving unit 11, then the unit 10 is inverted compared with the position shown in FIG. 1 and installation can occur with the latch arm being arranged to latch and extend to the opposite side of the unit 11 compared with that shown in FIG. 1.

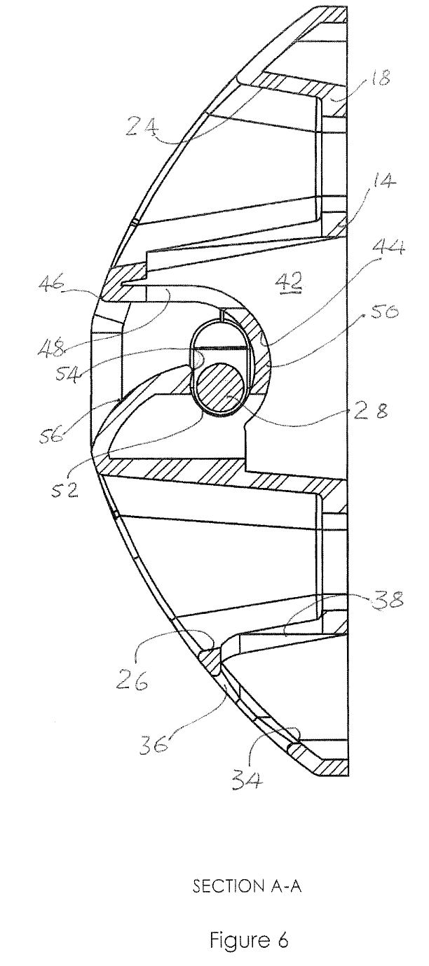

The receiving unit 11, as best shown in FIG. 6, has an additional lower aperture 34 formed in the body and having an opening 36 in the lower facia and an opening 38 in the central wall dividing the lower cavity 24 from the aperture 26. This is intended to permit a padlock to be stored with the hasp thereof extending through e.g. the opening 26, then down through the aperture 38 and back out of the opening 36 so the padlock may be stored when not in use in a closed condition if desired.

In the upper region, the receiving unit has a further aperture 40 defined in the wall separating the upper aperture 24 and a central cavity 42. An interior curved wall 44 extends from a main aperture 46 for admitting the toggle arm through a superior wall 48 to an anterior wall 50 to then join up with an inferior wall 52. A padlock hasp may thus be inserted through into the aperture 24, down through the aperture 40 and then through the superior aperture 48 to be locked in position thereby preventing removal of the latch arm from the latching position shown in FIG. 6.

It will be seen that the superior wall is substantially horizontal and rearwardly directed to blend into a smoothly curved posterior wall 44 with a slight decrease in the radius of curvature round the base of the toggle arm 28 to curve upwardly into an undercut or lip arrangement 54.

Thus, there is a substantial clearance between the toggle arm when it moves up the ramp surface 56 and the superior wall; on any impact of the toggle arm, with the anterior wall it is deflected forwardly and downwardly to adopt the position shown in FIG. 6 where retention occurs with the toggle arm located under gravity.

Typically the gap is such that the spacing between the lip 54 and the wall above and behind is about 1.3 times the diameter of the toggle arm.

It will be appreciated that the present invention lends itself readily to suitable styling and molded plastics material is preferable for both the units; the units can be complementary in form and general shape. The width of each unit (about 2 cm) lends itself to secure face mounting in a manner which can be functionally effect and advantageous. The height of each unit can be around 10 cm.

Furthermore by using glass-reinforced plastics material considerable strength, robustness and resistance to corrosion is provided. The barrel and latch arm can readily be made of the selected steel which is resistant to corrosion.

The materials chosen can lend themselves to a long period of service without maintenance.

What is claimed is:

1. A toggle latch for latching together first and second structures when in juxtaposition for latching at a closed position, the latch comprising a first unit having a body for mounting on the first structure,
a pivotally mounted latch arm projecting laterally and pivotal about a substantially horizontal axis,
a support for supporting the latch arm when free to limit normally downward pivoting of the latch arm,
a second unit for mounting on the second structure and receiving in latching engagement the latch arm, the second unit having a body portion within which a laterally directed aperture is defined for admitting the latch arm and a cavity for retaining the latch arm in latching engagement,
the body portion being characterized by a forward nose providing a ramp to deflect upwardly and over the nose the latch arm when impacting thereon, and an interior retainer surface defining upper and rear surfaces of the cavity and profiled to deflect down into the cavity the latch arm after it has ridden up over the nose.

2. A toggle latch as claimed in claim 1, wherein the body portion of each of the first unit the second unit is molded in plastics material.

3. A toggle latch as claimed in claim 1 wherein the first unit is invertible with two spaced supports for the latch arm to that when installed the latch arm may be directed to the left or to the right towards the second unit.

4. A toggle latch as claimed in claim 1, when the surfaces defining the cavity follow a complex curve decreasing in radius of curvature generally from the superior surface through the posterior surface to the forward surface.

5. A toggle latch as claimed in claim 1, wherein the nose is curved and its ramp surface is a ridge centrally disposed in the body of the second unit.

6. A toggle latch as claimed in claim 5, wherein the nose has lateral sides tapering towards the tip of the nose.

7. A toggle latch as claimed in claim 1, wherein the body of the first unit and body portion of the second unit are elongated in a vertical direction when installed with holes for fixing screws in upper and lower locations.

8. A toggle latch as claimed claim 1, wherein the latch arm is a round bar having a tip portion arranged to be exposed for manual lifting for unlatching, and at the opposite end a circular cross-section pivot portion extends normal to the axis of the arm and is engaged in a corresponding cavity in the body of the first unit.

9. A toggle latch as claimed in claim 1, wherein the upper surface of the cavity has a lead-in surface above the ramp and extending rearwardly substantially horizontally and smoothly blending into an actuate rear surface with a vertical gap at the rear, upper portion of the ramp to the upper surface of about 1.3 times the diameter of the latch arm and a horizontal gap between the end of the ramp and the rear actuate surface of about 1.3 times the diameter of the latch arm.

10. A toggle latch for latching together first and second structures when in juxtaposition for latching at a closed position, the latch comprising a first unit having a body for mounting on the first structure,
a pivotally mounted latch arm projecting laterally and pivotal about a substantially horizontal axis,
a support for supporting the latch arm when free to limit normally downward pivoting of the latch arm,
a second unit for mounting on the second structure and receiving in latching engagement the latch arm, the second unit having a body portion within which a laterally directed aperture is defined for admitting the latch arm and a cavity for retaining the latch arm in latching engagement,
the body portion being characterized by a forward nose providing a ramp to deflect upwardly and over the nose the latch arm when impacting thereon, and an interior retainer surface defining upper and rear surfaces of the cavity and profiled to deflect down into the cavity the latch arm after it has ridden up over the nose and wherein
the body portion of each of the first unit and the second unit is molded in plastics material, the first unit is invertible with two spaced supports for the latch arm to that when installed the latch arm may be directed to the left or to the right towards the second unit, and wherein the surfaces defining the cavity follow a complex curve decreasing in radius of curvature generally from a superior surface (which extends over an upper rearward end of the nose) through the posterior surface to the forward surface.

11. A toggle latch as claimed in claim 10 wherein the latch arm is a round bar having a tip portion arranged to be exposed for manual lifting for unlatching, and at the opposite end there is a circular cross-section pivot portion extending normal to the axis of the arm and engaged in a corresponding cavity in the body of the first unit.

12. A toggle latch as claimed in claim 11, wherein the superior surface of the cavity has a lead-in surface above the ramp and extending rearwardly substantially horizontally and smoothly blending into an actuate rear surface, with a vertical gap between the rear, upper portion of the ramp to the superior surface of about 1.3 times the diameter of the latch arm and a horizontal gap between the end of the ramp and the posterior actuate surface of about 1.3 times the diameter of the latch arm.
